(19) United States
(12) Patent Application Publication
(10) Pub. No.: US 2022/0154707 A1
(43) Pub. Date: May 19, 2022

(54) ELECTRIC VACUUM PUMP FOR BRAKING SYSTEM ON PASSENGER CARS WITH V-TWIN PISTON ARRANGEMENT

(71) Applicant: ZF CV Systems Europe BV, Brussels (BE)

(72) Inventors: Glyn Dyche, Harrogate (GB); David Heaps, Haworth (GB)

(21) Appl. No.: 17/439,415

(22) PCT Filed: Mar. 15, 2019
(86) PCT No.: PCT/EP2019/056590

§ 371 Date: Sep. 15, 2021

(51) Int. Cl. F04B 35/04; F04B 37/14; F04B 39/00; F04B 39/12; F04B 27/00

(52) U.S. Cl. CPC F04B 35/04; F04B 37/14; B60T 17/02; F04B 39/12; F04B 27/005; F04B 39/0022

(57) ABSTRACT

A vacuum pump is provided that includes a body, a first cylinder at least partially inside the body, a second cylinder at least partially inside the body, and an electric drive motor attached to the body and driving a common crank pin. The first cylinder has a first cylinder axis, and a first piston is reciprocal in the first cylinder. A first piston rod is attached to the first piston. The second cylinder has a second cylinder axis, and a second piston is reciprocal in the second cylinder. A second piston rod is attached to the second piston. The first and second cylinder axes are arranged at substantially 90° to each other. The first and second piston rods engage the common crank pin such that the first piston and the second piston are commonly driven by the common crank pin.

### CROSS-REFERENCE TO PRIOR APPLICATIONS

This application is a U.S. National Phase application under 35 U.S.C. § 371 of International Application No. PCT/EP2019/056590, filed on Mar. 15, 2019. The International Application was published in English on Sep. 24, 2020 as WO 2020/187389 under PCT Article 21(2).

### FIELD

The disclosure relates to a vacuum pump, comprising a body, a first cylinder at least partially inside the body with a first cylinder axis, a first piston reciprocal in the first cylinder and a first piston rod attached to the first piston, a second cylinder at least partially inside the body with a second cylinder axis, a second piston reciprocal in the second cylinder and a second piston rod attached to the second piston.

### BACKGROUND

Such a vacuum pump, in particular, is used for providing pressure for a brake actuation device of a motor vehicle with a pneumatic brake booster system. To provide vacuum for a pneumatic brake booster, vacuum pumps are used which suck in residual air from the vacuum chamber and eject it to atmosphere. In the automotive industry for this purpose usually vane pumps or swing vane pumps are used. A comparable vane pump for example is disclosed in WO 2007/141 511 A1. Such vane pumps are also called mono vane pumps since they incorporate one single vane which is slideable in a radial direction of a rotor. Such mono vane pumps have inherent friction and must be lubricated to achieve an acceptable lifetime. These types of pumps are usually driven from an internal combustion engine of a motor vehicle and connected to the oil circuit of that engine. These pumps draw some of the generated power from the engine in driving the vacuum pump and usually are rigidly connected and, therefore, are in constant operation whilst the engine is running. They are independent of a vacuum demand for the braking system, therefore it is useful to operate a vacuum pump with electrical energy independent of an internal combustion engine to operate and generate vacuum only when the brake booster system demands, this has the advantage of saving on emissions and fuel consumption for a vehicle with an internal combustion engine.

Furthermore, in a motor vehicle with an electric or hybrid drivetrain, the vacuum pump cannot be driven continuously from an internal combustion engine; therefore, electrically powered vacuum pumps may be used in these vehicles. Another alternative to this is a fully integrated non-vacuum brake system, however, the cost penalty of such a system allows market space for a lower cost vacuum system to still be relevant in these types of motor vehicles. Added to this is the potential for other vacuum operated systems to still be used on a vehicle and plumbed into the electrically operated vacuum source (i.e., pump).

An electrically driven pump which operates independently from an internal combustion engine therefore does not have a lubricant oil circuit to connect to. Thus an electrically driven pump for braking systems requires a dry-running or non-lubricated pump. To equip such a pump there are several versions in existence. In the form of a multi-vane type dry-running pump, a self-lubricating graphite material is used which requires great precision and expense. An example of a multi vane dry running pump for automotive applications is well known from WO 2017/067 819 A1.

The other dry-running pumps in existence are either diaphragm pumps or piston pumps with no lubrication. A diaphragm pump for automotive applications is known from WO 2010/069 963 A1, which describes a motor-pump unit for providing pressure for a brake actuating device. A diaphragm pump generates pressure by utilizing a reciprocating flexible membrane for fluid pressurization and due to this flexibility, it remains difficult to control the tolerances and the dead volume of the working space above the piston in the pump. The volume above a working face which retains a non-compressed fluid becomes a dead volume, contributing to a lower performance vacuum system.

Other dry-running pistons pumps in existence are usually multi-piston, 180 degree opposing types which are either linear articulated piston type or rocking non-articulating types. A twin opposing piston pump is known from WO 2011/054 189 A1. A downside with this pump arrangement is the cost and complexity and difficult assembly of the crank arrangement and offset forces from opposing crank pins.

A linear reciprocating piston pump of multi-piston type is suitable for this application, but becomes expensive because the separate piston and connecting rod must be provided with journal bearings at the big and little ends of the connecting rod.

Multiple pistons are required in an automotive vacuum pump to provide a working fluid volume to meet the performance requirements from an independent vacuum system on a vehicle. A single piston pump may not achieve the desired performance unless the working capacity of the pump is large enough, contributing to an unacceptable Noise Vibration and Harshness (NVH) from the pump. To reduce the NVH of a single piston pump requires an unacceptable cost element for additional balance componentry. A single piston vacuum pump is described in GB 2 263 139.

Therefore, efforts are being made to utilize a multiple piston pump, which offer benefits of NVH to provide the independent electrically drive vacuum source for braking systems as a low cost system.

The automotive industry places very high demands on the acoustic comfort of motor vehicle components and demands from their suppliers' robust durable pumps with low noise emissions. Also being an automotive field of application, there are always efforts to reduce the manufacturing costs and assembly costs. It is therefore an object of the present disclosure to provide a low-noise, cost-reduced motor-pump unit, which requires a reduced installation effort compared to the known, generic unit. Furthermore, the number of components should be reduced to keep costs low.

A problem with existing technology vacuum pumps, in particular reciprocating piston type pumps, is they can create excessive noise and vibration, through their dynamic balance. One reason for this being prevalent if they are a single reciprocating piston, it is difficult to achieve a good dynamic balance without the use of additional balancing mechanisms and cost. This is also prevalent for twin opposed reciprocating pistons pumps. Their pistons have to be coupled to the drive mechanism via opposing crank halves. A moment or shaking couple arises due to the axial spacing between the pistons.

Another problem with conventional pumps is to reduce the pumping noise generated; the exhaust air is sometimes run into the non-vacuum side of the piston. In this case if the pistons are opposed, the pressure pulsations generated equate to the full stroke of the reciprocated piston as both pistons act together to squeeze the crankcase volume. The air is then usually exhausted through a silencer element to atmosphere.

Another problem with single cylinder reciprocating piston pumps is to balance the primary forces of the reciprocating piston mass; the use of a rotating counterweight on the crank is made. However, when the piston mass is balanced at TDC (top dead center) by a counterweight, at crank angles past TDC or BDC (bottom dead center) of the piston, the counterweight force acts in a different direction to the reciprocating mass force. This “out of balance force” varies in magnitude and direction throughout the crank rotation therefore increasing the NVH of the pump.

### SUMMARY

In an embodiment, the present disclosure provides a vacuum pump. The vacuum pump includes a body, a first cylinder at least partially inside the body, a second cylinder at least partially inside the body, and an electric drive motor attached to the body and driving a common crank pin. The first cylinder has a first cylinder axis, and a first piston is reciprocal in the first cylinder. A first piston rod is attached to the first piston. The second cylinder has a second cylinder axis, and a second piston is reciprocal in the second cylinder. A second piston rod is attached to the second piston. The first and second cylinder axes are arranged at 90° to each other. The first and second piston rods engage the common crank pin such that the first piston and the second piston are commonly driven by the common crank pin.

The embodiments of the present disclosure solve the problems described above by a vacuum pump of the aforementioned type, wherein the first and second cylinder axes are arranged at substantially 90 degrees to each other, and an electric drive motor is attached to the body driving a common crank pin, wherein the first and the second piston rods engage said common crank pin for being commonly driven by said common crank pin. Due to the 90-degree arrangement of the cylinders, the present vacuum pump can be seen as a so-called V-format vacuum pump which has shown to be improved when it comes to sound damping. In particular, this allows both pistons to be driven by the common crank pin, such that part count is reduced and the overall design of the vacuum pump can be kept small. Moreover, this results in a simple construction of the vacuum pump with an improved balance and low noise for a twin reciprocating piston vacuum pump. Preferably, the body includes the crank case in which the common crank pin cranks. The electric drive motor is attached to the body, e.g., by means of a screw connection. The first and second cylinders are at least partially formed inside the body, but also can be formed mainly outside the body.

### BRIEF DESCRIPTION OF THE DRAWINGS

The present embodiments will be described in even greater detail below based on the exemplary figures. The disclosure is not limited to the exemplary embodiments. Other features and advantages of various embodiments of the present disclosure will become apparent by reading the following detailed description with reference to the attached drawings which illustrate the following:

FIG. 1 shows a perspective view of a vacuum pump according to an embodiment;

FIG. 2 shows a top view of the vacuum pump according to FIG. 1;

FIG. 3 shows a full cut through the vacuum pump along lines A-A according to FIG. 2;

FIG. 4 shows an enlarged view of a cylinder portion of the vacuum pump according to FIG. 3;

FIG. 5 shows a cut through the cylinder portion according to FIG. 4 along a plane perpendicular to the drawing of FIG. 4;

FIG. 6 shows an exploded view of the vacuum pump according to FIG. 1;

FIG. 7 shows a full cut view along lines B-B according to FIG. 2;

FIG. 8 shows a full cut view similar to FIG. 7, with the cut running through a cylinder;

FIG. 9 shows a perspective view of a resonator insert;

FIG. 10 shows a first diagram showing a volume change in the crank case; and

FIG. 11 shows a second diagram showing piston pump torque calculations over the crank angle.

### DETAILED DESCRIPTION

According to a first preferred embodiment, the first piston is rigidly attached to the first piston rod and the second piston is rigidly attached to the second piston rod. Preferably, a piston and piston rod are formed as an integral part, i.e., as a one-piece construction. It should be understood that also articulated pistons are contemplated, however a rigidly attached piston to a piston rod is more simple to manufacture. Using such type of piston and piston rods, a so-called rocking or wobble piston compressor is provided. The piston will rock inside the cylinder, as the common crank pin rotates. This, again, results in a reduced part count and reduced manufacturing costs.

Furthermore, it is preferred that the first and the second cylinder axes are in a common plane, wherein the first piston rod is offset from the first cylinder axis and from a center of the first piston by a first piston offset, and the second piston rod is offset from the second cylinder axis and from a center of the second piston by a second piston offset. The piston rods are thus respectively offset from the common plane, formed by the two cylinder axes and from each other, to account for them being driven by the common crank pin. They might be designed to be close to each other, but preferably not touching each other, to reduce friction. Preferably, both piston and piston rod combinations are formed identical to each other, so that part count can further be reduced. Thus, the piston and piston rods are preferably symmetrical.

In a further preferred embodiment, the vacuum pump comprises a first cylinder head for closing said first cylinder and a second cylinder head for closing said second cylinder, wherein said first and second cylinder heads are attached to said body. The first and the second cylinder heads are preferably attached to said body by screws. The sealing ring may be provided between cylinder heads and body. Preferably, the first and second cylinder heads are identical to each other so that the part count can be reduced and maintenance simplified. The first and the second cylinders are at least partially formed inside the cylinder heads.

According to a further preferred embodiment, the body comprises a central inlet for connecting the vacuum pump to a consumer, a first body conduit and a second body conduit in fluid communication with said central inlet, wherein said first cylinder head comprises a first head conduit in fluid communication with said first body conduit and terminating in said first cylinder, and wherein said second cylinder head comprises a second head conduit in fluid communication with said second body conduit and terminating in said second cylinder. Due to this arrangement, the central inlet is connected to both, the first and the second cylinders via the first and second body conduits and the first and second head conduits, respectively. The conduits are respectively formed such that they are connected to each other when the cylinder heads are mounted to the body. In particular, it is contemplated that the cylinder heads are identical to each other, such that first and second body conduits are preferably provided in such a manner that a simple connection with the first and second head conduits is achievable. Additional sealing means between the first and the second head conduits and the first and the second body conduits, respectively, can be provided, such as an O-ring.

The first cylinder head preferably comprises a first inlet valve and said second cylinder head preferably comprises a second inlet valve. The first and second inlet valves are preferably located at terminating ends of the first and second head conduits. The first and second inlet valves are preferably formed as one-way valves and more preferably as an umbrella valve. In case the vacuum pump is used to induce a vacuum at the common inlet, the first and second inlet valves preferably open into the direction of the cylinder and block flow of fluid out of the cylinder into the direction of the first and second head conduits. It should be understood that the vacuum pump also could be used as a compressor. In this case, the opening direction of the first and second inlet valves preferably is vice versa, i.e., the first and second inlet valves open into the direction from the first and second cylinders into the first and second head conduits, and block flow of fluid from the first and second head conduits into the first and second cylinders. Preferably, the first and second inlet valves are positioned coaxially with the first and second cylinder axes, so that they are substantially in a center of the first and second cylinders.

Furthermore, it is preferred that the first piston comprises a first piston seal at a perimeter of said first piston for sealing and guiding the first piston within the first cylinder, and wherein the second piston comprises a second piston seal at a perimeter of said second piston for sealing and guiding the second piston in the second cylinder. Preferably, the first and the second piston seals are formed as sealing rings or cup seals. In case they are formed as a cup seal, the opening direction of the cup shape is into the direction of the piston rod, when the vacuum pump is used to induce a vacuum at the common inlet. In case the vacuum pump is used as a compressor, the opening direction of the cup-shaped cup seals preferably is into the direction away from the piston rod, thus into the direction of the first and the second inlet valves. The first and the second piston seals are used to guide the first and the second pistons in the respective cylinders, and allow for the rocking movement as described above of the first and the second pistons. Thus, the first and the second piston seals are preferably formed out of a low friction material, such as a dry-running PTFE compound.

For discharging the air, preferably the first piston comprises a first outlet valve and the second piston comprises a second outlet valve. The first and the second outlet valves are formed inside the first and the second pistons and allow air, which is drawn by the piston movement through the first and the second inlet valves into the cylinder to escape through the first and the second pistons, in particular into the crank case formed inside the housing. Again, the first and second outlet valves are preferably formed as one-way valves and more preferably as an umbrella valves. Preferably, they open into the direction of the piston rod and block flow of fluid from the piston rod side of the piston to the cylinder side of the piston. When the vacuum pump is used as a compressor, the opening direction of the first and second outlet valve preferably is arranged vice versa, i.e., in this case, the first and the second outlet valves open into a direction of the first and second cylinders and close into a direction of the first and the second piston rods.

Moreover, it is preferred that the first outlet valve is offset from the first cylinder axis by a first valve offset and the second outlet valve is offset from the second cylinder axis by a second valve offset. Preferably, the first and second outlet valves are offset opposite the offset of the first and second piston rods which allows for an enlarged outlet valve and a greater stability of the piston. In particular, the piston rods do not need to be reshaped or adapted to the first and second outlet valves, when they are respectively offset.

According to a further preferred embodiment, the body comprises a central outlet for discharging air. The central outlet preferably is in fluid communication with the crank case which in turn is in fluid communication with a discharge side of the first and second outlet valves of the first and second pistons, respectively. The central outlet may be provided with a silencer or a filter, for reducing the sound emission of the vacuum pump.

Furthermore, it is preferred that the body comprises a crank case in which the common crank pin cranks, wherein said crank case comprises a resonator volume which is shaped for acting as a Helmholtz resonator. A Helmholtz resonator generates through resonance sound waves which allow cancelling of sound waves entering the Helmholtz resonator. When the first and second pistons are driven, they will each generate sound waves or pressure waves through their respective movement which run into the crank case. In the crank case these sound or pressure waves are reflected and run back toward the first and second pistons. By forming the crank case as a Helmholtz resonator, sound emission of the vacuum pump can be greatly reduced.

Preferably, the crank case contains an inlet into said resonator volume so that the crank case works as a Helmholtz resonator. In particular, the sound waves exiting the inlet from the crank case eliminate sound waves which are coming from the first and second piston heads and run toward the inlet.

For forming the Helmholtz resonator, it is preferred that the body comprises a resonator insert for at least partially restricting said resonator volume. The insert may be formed out of a plastic material and can be shaped to effectively form the resonator volume. The insert should, however, comprise inlets or recesses for accounting for the respective first and second piston rods which run from the inside of the crank case toward the first and second cylinders.

According to a further preferred embodiment, the vacuum pump comprises a first cylinder tube defining said first cylinder and a second cylinder tube defining said second cylinder. Preferably, the first and second cylinder tubes are at least partially in said body and/or in said first and second cylinder heads, respectively. For example, the cylinder tubes may be formed out of a low friction material, such as aluminum, and are attached within the first and the second cylinder heads, and held in place against the body by the first and the second cylinder heads screwed against the body. Moreover, it is contemplated that the first and second cylinder tubes are seated within the body and simply closed or covered by means of the first and the second cylinder heads.

Moreover, it is suggested forming the body and the first and second cylinder heads from a plastic compound and the first and second cylinder tubes from an aluminum material. Due to such an embodiment, production costs of the vacuum pump can be reduced, while still reducing maintenance costs due to a low friction contact between the aluminum cylinder tubes and the respective first and second piston seals.

According to a second aspect of the disclosure, the above-mentioned object is solved by a vehicle, in particular a passenger car, comprising the vacuum pump according to any of the preceding described preferred embodiments of the vacuum pump according to the first aspect of the disclosure.

For a more complete understanding of the embodiments of the present disclosure, the embodiments will now be described in detail with reference to the accompanying drawings. The detailed description will illustrate and describe what is considered as a preferred embodiment of the disclosure. It should of course be understood that various modifications and changes in form or detail could readily be made without departing from the spirit of the disclosure. It is therefore intended that the embodiments of the disclosure may not be limited to the exact form and detail shown and described herein, nor to anything less than the whole of the scope disclosed herein and as claimed below. Further, the features described in the description, the drawings, and the claims disclosing the embodiments may be essential for the embodiments, considered alone or in combination. In particular, any reference signs in the claims shall not be construed as limiting the scope of the disclosure. The wording “comprising” does not exclude other elements or steps. The word “a” or “an” does not exclude the plurality. The wording “a number of” items comprising also the number 1, i.e., a single item, and further numbers like 2, 3, 4, and so forth.

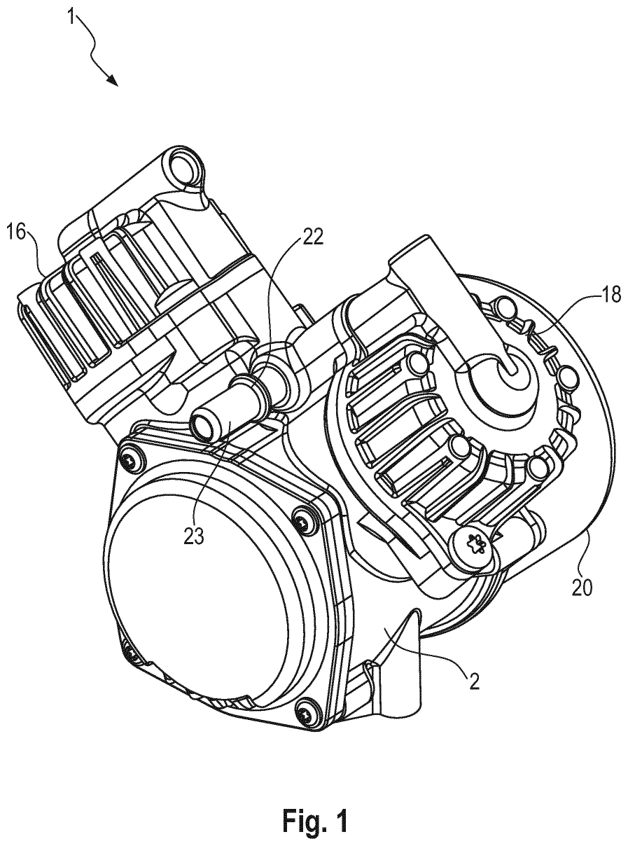

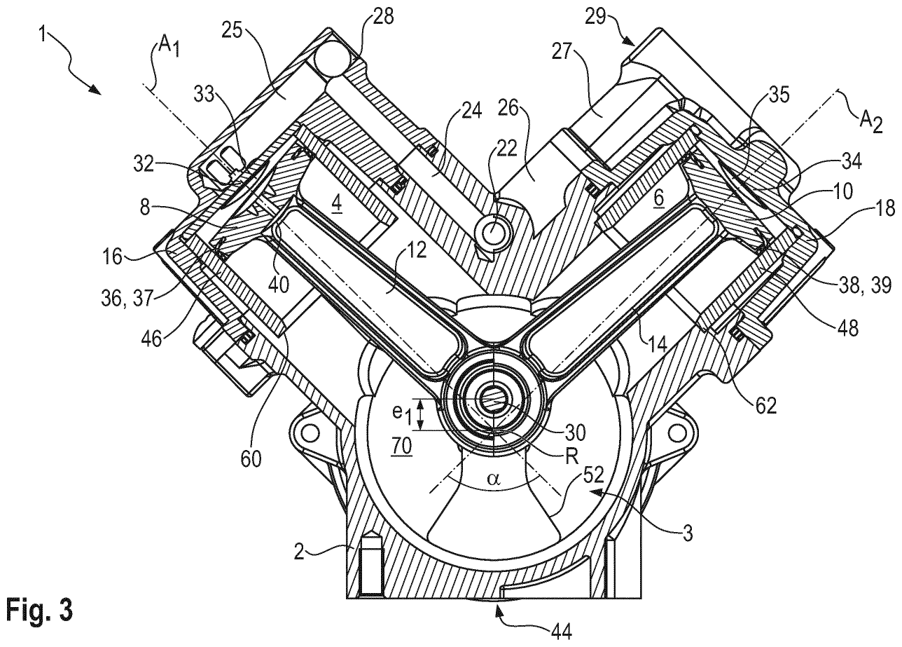

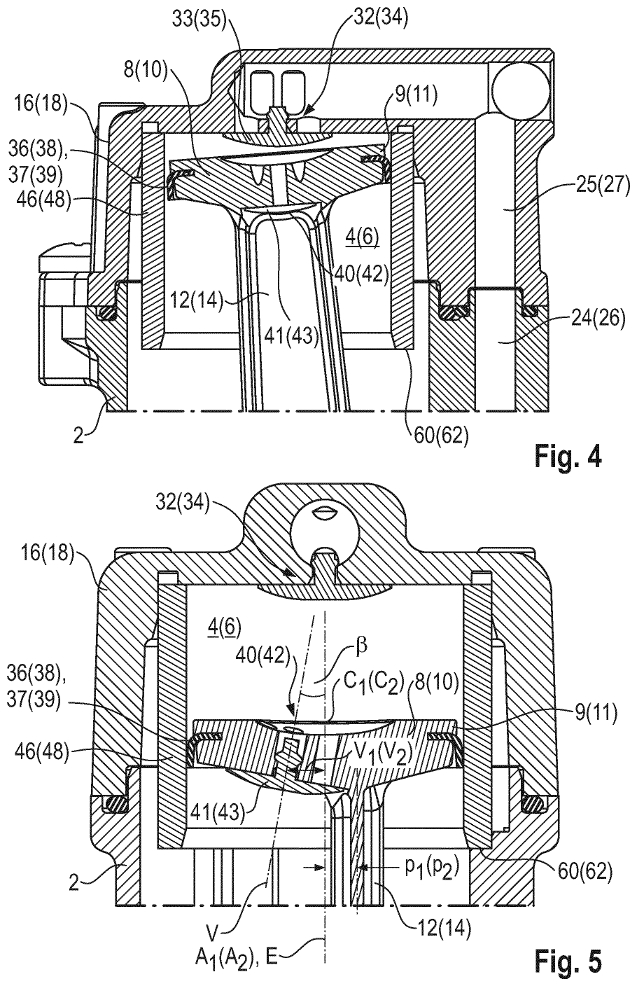

A vacuum pump 1 (see FIG. 1) includes a body 2 which defines a crank case 3 (see FIG. 3). The body 2 also at least partially defines a first cylinder 4 and a second cylinder 6 in which respective first and second pistons 8, 10 are reciprocatingly positioned.

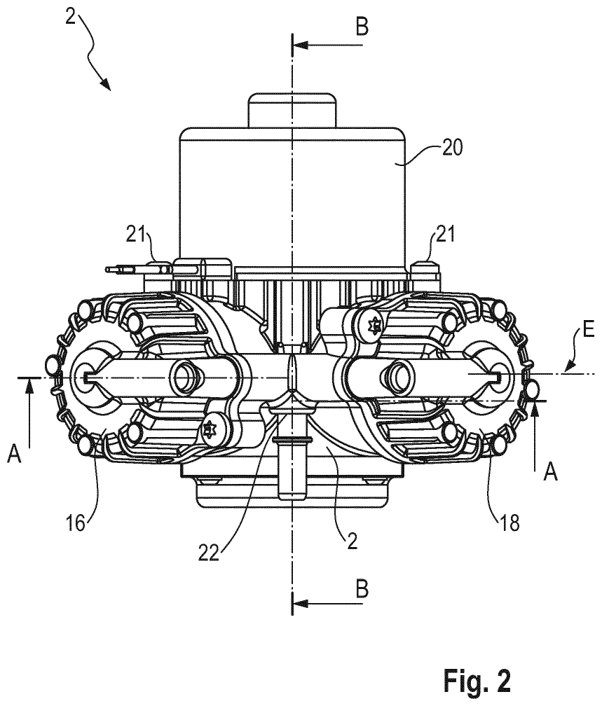

The first cylinder 4 comprises a first cylinder axis A1 (see FIG. 3) and the second cylinder 6 comprises a second cylinder axis A2. The first and second cylinder axes A1, A2 are formed in a common plane E (see FIG. 2) and include an angle α, which in this case is 90 degrees. It shall be understood that also small deviations thereof are contemplated within the scope of the present disclosure.

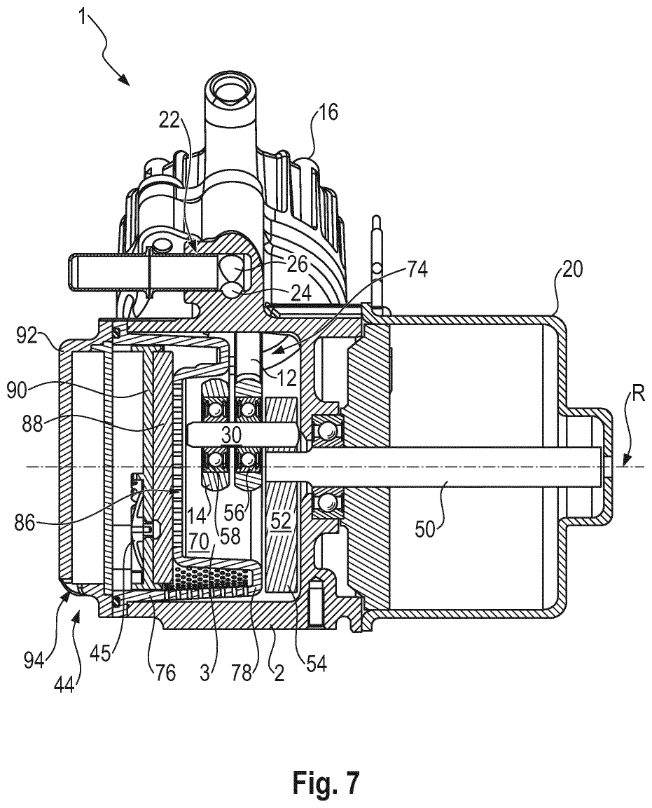

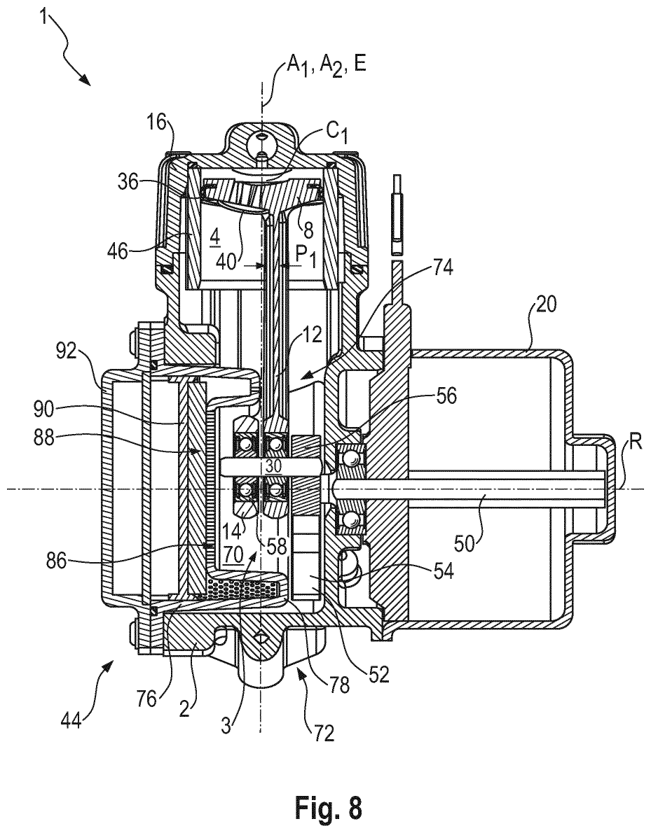

For driving the first and the second pistons 8, 10, the vacuum pump 1 comprises an electric drive motor 20 attached to the body 2. In particular, the electric drive motor 20 is attached to body 2 via screws 21 (see FIG. 2). The electric drive motor comprises a drive shaft 50 (see FIGS. 7 and 8) which rotates about a rotational axis R. The drive shaft 50 is coupled to a crank plate 52 which in turn carries a common crank pin 30. Common crank pin 30 is eccentrically attached to crank plate 52 by an eccentricity e1 (see FIG. 3). The value of eccentricity e1 is dependent on the actual size of the vacuum pump 1 and in particular of the size of cylinders 4, 6. The crank plate 52 is non-rotationally symmetric and comprises a weight portion 54 for accounting for a weight compensation when driving the first and second pistons 8, 10.

Common crank pin 30 drives both, the first and second pistons 8, 10 by carrying both, the first and the second piston rod 14, 16. In particular, the first and second piston rods 12, 14 are seated on common crank pin 30 by means of first and second roller bearings 56, 58 (see FIG. 7). This is done for reducing friction in the vacuum pump 1. Since the first and second cylinder axes A1, A2 are arranged at a 90-degree angle to each other, the first and second pistons 8, 10 will reach the TDC and BDC, respectively, at different angles of the drive shaft 50. This should reduce noise and vibration, as compared to first and second cylinders in a row. Also, when compared to a boxer arrangement (i.e., wherein angle α is 180 degrees), the volume of the whole system and in particular the volume of the crank case 3 can be reduced. The volume of air moved is reduced which results in reduced sound and noise generation.

The first and second cylinders 4, 6 are respectively partially formed in the body 12 and partially formed in first and second cylinder heads 16, 18 which are attached to body 2. The first and second cylinder heads 16, 18 are identically formed, so that the part count may be reduced.

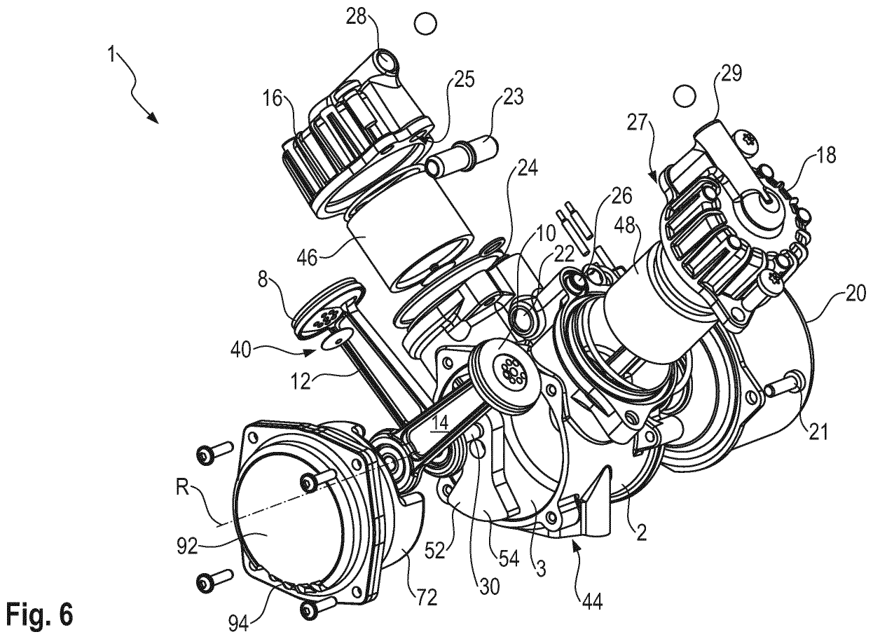

For connecting a consumer to the vacuum pump 1, vacuum pump 1 comprises a central inlet 22, formed in the body 2. Central inlet 22 in the embodiment shown in FIG. 1 is provided with an inlet fitting 23 which, for example, can be formed as a hose connector or the like. From the central inlet 22 within body 2, first and second body conduits 24, 26 are branching off which in turn are in fluid communication with central inlet 22 (see FIGS. 3 and 6).

For connecting those first and second body conduits 24, 26 with the respective first and second cylinders 4, 6, the first cylinder head 16 comprises a first head conduit 25 and the second cylinder head 18 comprises a second head conduit 27. According to the shown embodiment, first and second head conduits 25, 27 comprise first and second side inlets 28, 29 which, however, are regularly closed off.

The first head conduit 25 terminates centrally with the first cylinder axis A1 at the first cylinder 24 and is provided with a first inlet valve 32. Respectively, the second head conduit 27 terminates at the second cylinder 6 centrally with the second cylinder axis A2 and is provided with a second inlet valve 34. The first and second inlet valves are formed as so-called umbrella valves and comprise first and second inlet valve elements 33, 35 which are formed for an elastic material and can open in a direction into the first and second cylinders 4, 6, respectively, such that air may flow through the first and second head conduits 25, 27 into the first and second cylinders 4, 6, when the respective first and second pistons 8, 10 move toward the crank case 3.

For inducing a vacuum between the first piston 8 and the first inlet valve 32, and the second piston 10 and the second inlet valve 34, respectively, the first and the second pistons 8, 10 comprise first and second piston seals 36, 38. The first piston seal 36 is provided at a first perimeter 9 of the first piston 8. The first and second piston seals 36, 38 in general could be formed in any suitable manner, e.g., as a sealing ring or other sealing means which allow guidance of a rocking piston within the cylinder 4, 6. In the shown embodiment, the first and the second piston seals 36, 38 are formed as so-called cup seals 37, 39. The first and second cup seals 37, 39 are arranged such that an opening of the cup shape of the first and second cup seals 37, 39 opens into the direction of the first and the second piston rods 12, 14. Thus, the first and second cup seals 37, 39 are able to withstand a relatively high pressure.

For guiding the first and second pistons 8, 10 by using the first and second piston seals 36, 38 within the first and second cylinders 4, 6, the first and second cylinders 4, 6 are provided with first and second cylinder tubes 46, 48. Preferably, the first and second cylinder tubes 46, 48 are fixedly held within the first and second cylinder heads 16, 18, respectively and preferably also seated on first and second body abutments 60, 62 (cf., FIG. 3) formed in body 2. Due to such an arrangement, there are no additional positioning means necessary for fixing the first and second cylinder tubes 46, 48 which again reduces part count. The first and second cylinder tubes 46, 48 preferably are formed from aluminum material which provides for a low weight vacuum pump and also a low friction surface for contact with the first and second piston seals 36, 38.

For ejecting air, which is compressed between the respective first and second pistons 8, 10 and the first and second inlet valves 32, 34, respectively, when the first and second pistons 8, 10 move upwards toward the first and second inlet valves 32, 34, the first and second pistons 8, 10 comprise respective first and second outlet valves 40, 42. The first and second outlet valves 40, 42 are again formed as umbrella valves and comprise first and second outlet valve elements 41, 43 which open in a direction toward the first and second piston rods 12, 14.

As in particular can be seen in FIGS. 5 and 8, the respective first and second outlet valves 40, 42 are offset from a respective center C1, C2 of the first and second pistons 8, 10. That is, a central axis V of the first and the second outlet valves 41, 43 is not coaxial with the central axes A1, A2 of the first and second cylinders 4, 6, but rather offset to this axis when the first and second pistons 8, 10 are in a position in which the common crank pin 30 is centered with respect to the respective first and second piston axes A1, A2. The first and second valve offsets V1, V2 of the first and the second outlet valves 40, 42 is measured from the central outlet point of the first and second outlet valves 40, 42 and the central axes A1, A2 of the first and second cylinders 4, 6. Moreover, the central axis of the first and second outlet valves 40, 42 is angled with respect to the first and second cylinder axes A1, A2 which allows an enlarged outlet valve 40, 42 and therefore a more efficient use of the vacuum pump 1.

Additionally, it can be inferred that the first and second piston rods 12, 14 are also offset with respect to the first and second cylinder axes A1, A2 and with respect to the common plane E of the first and the second cylinder axes A1, A2. In particular, both, the first and the second piston rods 12, 14 are offset by respective first and second piston offsets P1, P2 which preferably have the same amount. By offsetting the first and second piston rods 12, 14 from the respective first and second cylinder axes A1, A2, there is enough space for the first and second piston rods to be driven by the common crank pin 30.

After the air has been ejected through the first and second outlet valves 40, 42, respectively, the air passes through the crank case 3 and then through a central outlet 44. The central outlet 44 is provided with an eject valve 45, again formed as an umbrella valve.

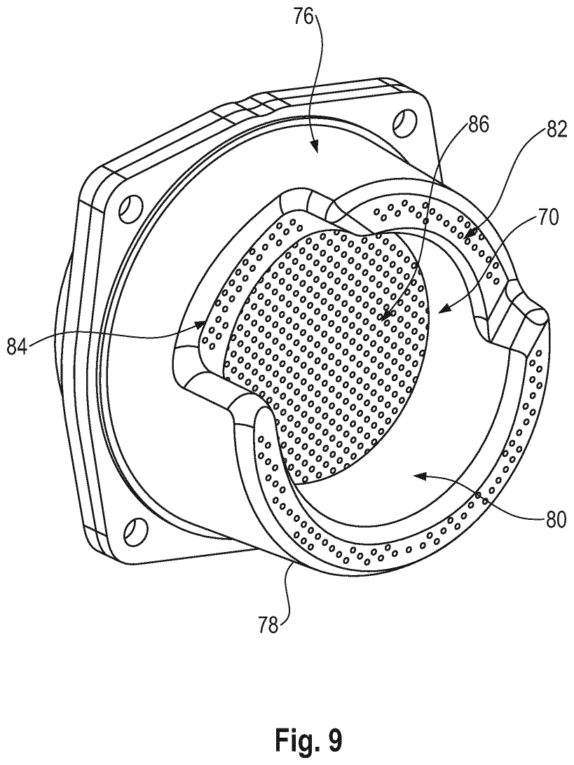

The crank case 3 comprises a resonator volume 70 which is shaped for acting as a Helmholtz resonator 72. For achieving this, the crank case 3 contains an inlet 74 (depicted by the horizontal ghost line in FIG. 8) separating the resonator volume 70 from the volume inside the body 2 and first and second cylinder heads 16, 18. When the respective first and second pistons 8, 10 move toward the rotational axis R, thus toward the crank case 3, they push some air toward the crank case 3 so that a pressure or sound wave runs through the inlet 74 into the resonator volume 70 in the crank case 3. For defining the resonator volume 70, the vacuum pump 1 comprises a resonator insert 76 which, in a perspective view, is also shown in FIG. 9. The resonator insert 76 partially restricts the resonator volume by providing a rim portion 78. The rim portion 78 substantially includes a cavity portion 80 which substantially defines the resonator volume 70. The rim portion 78 comprises a first recess 82 and a second recess 84 which are formed to allow movement of the first and the second piston rods 12, 14.

In its body portion, the resonator insert 76 comprises a plurality of openings 86 which grant access to a space 88 between a valve wall 90 and a closure lid 92, both attached to body 2. The valve wall 90 carries the eject valve 45 and does not comprise any other openings beside this eject valve 45. Within space 88, a damping filter or the like can be provided. This again may reduce noise generation. The closure lid 92 comprises slots 94 at a lower end thereof, to finally let the air pass to the environment.

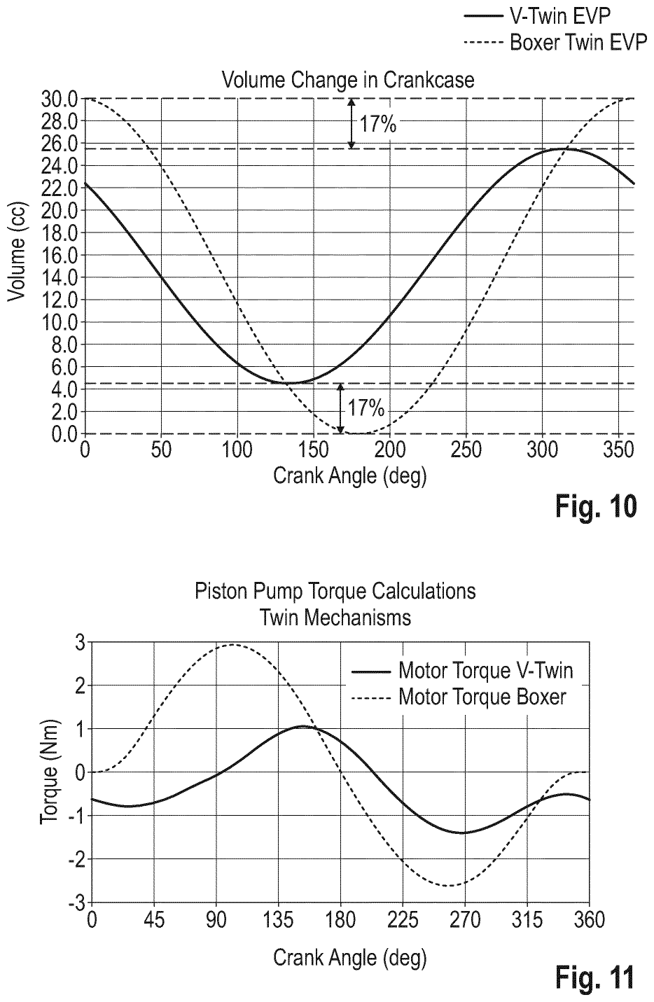

FIG. 10 shows a first diagram, comparing the volume of air which is moved around in the inside of the body 2 and in particular inside the crank case 3 due to movement of the first and second pistons 8, 10 in a V-Twin EVP which is the vacuum pump 1 of the present disclosure and a Boxer Twin EVP which is a vacuum pump with angle α at 180 degrees. What can be seen in FIG. 10 is that for both maximum rotation points of the first and the second pistons 8, 10, the volume of air moved is decreased by 17%, which results in a higher efficiency of the vacuum pump 1 according to the present disclosure as well as a reduced noise level. FIG. 11 illustrates the torque necessary to drive the vacuum pump 1 according to the present disclosure (motor torque V-Twin), compared to a Boxer-type vacuum pump (motor torque Boxer) which is a vacuum pump 1 with angle α at 180 degrees. What can be seen in FIG. 11 is that the required motor torque for the vacuum pump according to the present disclosure is greatly reduced compared with prior art vacuum pumps, thus leading to a higher efficiency and lower energy consumption of the vacuum pump 1 according to the present disclosure.

While the embodiments have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and/or below. Additionally, statements made herein characterizing an embodiment refer to an embodiment of the disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS (PART OF THE SPECIFICATION)

1 vacuum pump
2 Body
3 crank case
4 first cylinder
6 second cylinder
8 first piston
9 first perimeter
10 second piston
11 second perimeter
12 first piston rod
14 second piston rod
16 first cylinder head
18 second cylinder head
20 electric drive motor
21 Screws
22 central inlet
23 inlet fitting
24 first body conduit
25 first head conduit
26 second body conduit
27 second head conduit
28 first side inlet
29 second side inlet
30 common crank pin
32 first inlet valve
33 first inlet valve element
34 second inlet valve
35 second inlet valve element
36 first piston seal
37 first cup seal
38 second piston seal
39 second cup seal
40 first outlet valve
41 first outlet valve element
42 second outlet valve
43 second outlet valve element
44 central outlet
45 eject valve
46 first cylinder tube
48 second cylinder tube
50 drive shaft
52 crank plate
54 weight portion
56 first roller bearing
58 second roller bearing
60 first body abutment
62 second body abutments
70 resonator volume
72 Helmholtz-resonator
74 inlet of crank case
76 resonator insert
78 rim portion
80 Cavity
82 first recess
84 second recess
86 Holes
88 Space
90 valve wall
92 closure lid
94 slots in closure lid
A1 first cylinder axis
A2 second cylinder axis
e1 Eccentricity
E common plane
α Angle
R rotational axis
C1 first piston center
C2 second piston center
V central axis of outlet valve
V1 first valve offset
V2 second valve offset
P1 first piston offset
P2 second piston offset

1. A vacuum pump, comprising
a body,
a first cylinder at least partially inside the body with a first cylinder axis, a first piston reciprocal in the first cylinder and a first piston rod attached to the first piston,
a second cylinder at least partially inside the body with a second cylinder axis, a second piston reciprocal in the second cylinder and a second piston rod attached to the second piston,
wherein the first and second cylinder axes are arranged in a V-format; and
an electric drive motor attached to the body and driving a common crank pin, wherein the first and second piston rods engage the common crank pin such that the first piston and the second piston are commonly driven by the common crank pin.

2. The vacuum pump according to claim 1, wherein the first piston is rigidly attached to the first piston rod, and the second piston is rigidly attached to the second piston rod.

3. The vacuum pump according to claim 1, wherein the first and second cylinder axes are in a common plane; and
wherein the first piston rod is offset from the first cylinder axis and from a center of the first piston by a first piston offset, and
wherein the second piston rod is offset from the second cylinder axis and from a center of the second piston by a second piston offset.

4. The vacuum pump according to claim 1, further comprising a first cylinder head closing the first cylinder and a second cylinder head closing the second cylinder, wherein the first and second cylinder heads are attached to the body.

5. The vacuum pump according to claim 4, wherein the body comprises a central inlet for connecting the vacuum pump to a consumer, a first body conduit and a second body conduit in fluid communication with the central inlet, and wherein the first cylinder head comprises a first head conduit in fluid communication with the first body conduit and terminating in the first cylinder, and the second cylinder head comprises a second head conduit in fluid communication with the second body conduit and terminating in the second cylinder.

6. The vacuum pump according to claim 4, wherein the first cylinder head comprises a first inlet valve and the second cylinder head comprises a second inlet valve.

7. The vacuum pump according to claim 1, wherein the first piston comprises a first piston seal at a perimeter of the first piston that provides a seal between the first piston and a surface of the first cylinder, and wherein the second piston comprises a second piston seal at a perimeter of the second piston that provides a seal between the second piston and a surface of the second cylinder.

8. The vacuum pump according to claim 1, wherein the first piston comprises a first outlet valve and the second piston comprises a second outlet valve.

9. (canceled)

10. The vacuum pump according to claim 8, wherein the first outlet valve is offset from the first cylinder axis by a first valve offset, and the second outlet valve is offset from the second cylinder axis by a second valve offset.

11. The vacuum pump according to claim 1, wherein the body comprises a central outlet for discharging air.

12. The vacuum pump according to claim 11, wherein the body further comprises a crank case, wherein the common crank pin is disposed in the crank case, and wherein the crank case comprises a resonator volume which is shaped to act as a Helmholtz resonator.

13. The vacuum pump according to claim 12, wherein the crank case comprises an inlet into the resonator volume.

14. The vacuum pump according to claim 12, wherein the body comprises a resonator insert that at least partially restricts the resonator volume.

15. The vacuum pump according to claim 1, further comprising a first cylinder tube defining the first cylinder and a second cylinder tube defining the second cylinder.

16. The vacuum pump according to claim 15, wherein the first and second cylinder tubes are at least partially in the body and/or in the first and second cylinder heads, respectively.

17. The vacuum pump according to claim 15, wherein the body and the first and second cylinder heads are formed from a plastic compound, and the first and second cylinder tubes are formed from an aluminium material.

18. A vehicle comprising the vacuum pump according to claim 1.
